(19) United States
(12) Patent Application Publication
(10) Pub. No.: US 2009/0176110 A1
(43) Pub. Date: Jul. 9, 2009

(54) EROSION AND CORROSION-RESISTANT COATING SYSTEM AND PROCESS THEREFOR

(75) Inventors: Surinder Singh Pabla, Greer, SC (US); Jon Conrad Schaeffer, Simpsonville, SC (US); Vinod Kumar Pareek, Albany, NY (US); David Vincent Bucci, Simpsonville, SC (US); Thomas Moors, Simpsonville, SC (US); Jane Marie Lipkin, Niskayuna, NY (US)

Correspondence Address: Hartman & Hartman, P.C., 552 E. 700 N., Valparaiso, IN, 46383, US

(73) Assignee: GENERAL ELECTRIC COMPANY, Schenectady, NY (US)

(21) Appl. No.: 11/970,604

(22) Filed: Jan. 8, 2008

(51) Int. Cl. C23C 4/10; B32B 15/04

(52) U.S. Cl. 428/450; 428/457; 428/472.2; 428/469; 427/453; 427/452

(57) ABSTRACT

A coating system and process capable of providing erosion and corrosion-resistance to a component, particularly a steel compressor blade of an industrial gas turbine. The coating system includes a metallic sacrificial undercoat on a surface of the component substrate, and a ceramic topcoat deposited by thermal spray on the undercoat. The undercoat contains a metal or metal alloy that is more active in the galvanic series than iron, and electrically contacts the surface of the substrate. The ceramic topcoat consists essentially of a ceramic material chosen from the group consisting of mixtures of alumina and titania, mixtures of chromia and silica, mixtures of chromia and titania, mixtures of chromia, silica, and titania, and mixtures of zirconia, titania, and yttria.

### BACKGROUND OF THE INVENTION

The present invention generally relates to protective coatings and coating processes for turbine components. More particularly, the invention relates to a coating system suitable for use on steel compressor blades of a gas turbine to promote the water droplet erosion and corrosion resistance of the blades.

On-line water wash, fogging, and evaporate cooler systems have been employed to improve the performance of compressors of large industrial gas turbines, such as those used by utilities to generate electricity. These systems generally entail introducing water droplets at the compressor inlet, with the result that the blades of the first stage of the compressor are impacted by water droplets at high velocities. Compressor blades formed of iron-based alloys, including series 400 stainless steels, are prone to water droplet erosion at their leading edges, including their roots where the blade airfoil attaches to the blade platform. The blades are also susceptible to corrosion pitting along the leading edge surfaces of the blades resulting from a build-up of fouling particles that cause galvanic attack. Corrosion is exacerbated if the turbine operates in or near a corrosive environment, such as near a chemical or petroleum plant or near a body of saltwater.

Because compressor blades are under tremendous stress due to centrifugal forces and vibration, pits and crevices located at the blade roots can lead to high cycle fatigue (HCF) cracking and, if the blade is not removed, eventual loss of the blade. Accordingly, there is significant interest in reducing the potential for crack formation in compressor blades arising from blade erosion due to water droplet impingement. While blades formed of nickel and titanium alloys are capable of exhibiting improved corrosion resistance, they do not necessarily exhibit improved resistance to water droplet erosion. Attempts to relieve leading edge stresses have included design features at the blade root, such as approaches disclosed in commonly-assigned U.S. Pat. Nos. 6,902,376 and 7,165,944. Alternatively or in addition, a variety of coating systems have been proposed for the purpose of improving the corrosion resistance of turbine components. Examples include coating systems reported in U.S. Pat. No. 3,248,251 to Allen and U.S. Pat. Nos. 4,537,632 and 4,606,967 to Mosser as containing particles (e.g., aluminum powder) in an inorganic binder, preferably a mixture of phosphate and chromate. The coating systems can be applied by spraying, followed by curing.

Another type of protective coating system is described in commonly-assigned U.S. Pat. No. 5,098,797 to Haskell as utilizing a metallic sacrificial undercoat and a ceramic overcoat. Suitable materials for the sacrificial undercoat are said to be any metal or metal alloy standing above iron in the electromotive force series, examples of which include aluminum, zinc, cadmium, magnesium and their alloys, and the resulting sacrificial undercoat is said to be a coherent body in electrically-conductive contact with the blade surface. Haskell's ceramic overcoat is described as preferably having the same composition and being deposited in the same manner as Allen, namely, aluminum particles in a phosphate/chromate binder.

Notwithstanding the above advancements, further improvements in the ability of compressor blades to resist water droplet erosion and corrosion would be desirable.

### BRIEF SUMMARY OF THE INVENTION

The present invention provides a coating system and process capable of providing erosion and corrosion-resistance to a component, particularly a steel compressor blade of an industrial gas turbine.

The coating system includes a metallic sacrificial undercoat on a surface of the component, and a ceramic topcoat deposited by thermal spray on the undercoat. The undercoat contains a metal or metal alloy that is more active in the galvanic series than iron, and electrically contacts the surface of the component. The ceramic topcoat consists essentially of a ceramic material chosen from the group consisting of mixtures of alumina and titania, mixtures of chromia and silica, mixtures of chromia and titania, mixtures of chromia, silica and titania, and mixtures of zirconia, titania and yttria. The coating system may optionally include a polymeric sealer to seal its surface, providing protection from ingress of corrosive agents and also improving the solid particle and water droplet erosion characteristics of the coating by virtue of its elastic nature.

The process of forming the coating system entails depositing the metallic sacrificial undercoat, preferably so that the constituents of the undercoat are consolidated to ensure electrical contact with the surface of the component. The ceramic material is then thermal sprayed on the undercoat to yield a ceramic topcoat that is harder and more erosion-resistant than the undercoat and the surface of the component.

A significant advantage of this invention is the ability of the coating system to provide both corrosion resistance and resistance to erosion by water droplet, thereby enhancing the corrosion pitting and crevice corrosion resistance of the protected surface, which in the case of a compressor blade has the potential for greatly extending the life of the blade. The coating system takes advantage of the fact that a sacrificial undercoat bonded to and electrically contacting the surface of a compressor blade will provide excellent corrosion resistance, while a hard topcoat will provide a shield against erosion by water impingement and thus reduce the incidence of pitting and crevice corrosion. The coating system can be strategically placed on a compressor blade, with the thickness of the coating tailored to provide the desired benefits while minimizing any loss in aerodynamic performance of the airfoil attributable to the coating system. Additional benefits of the coating system are believed to include the ability to enhance the blade anti-fouling capability and damage tolerance of a rotating blade.

Other objects and advantages of this invention will be better appreciated from the following detailed description.

### BRIEF DESCRIPTION OF THE DRAWINGS

FIG. 1 represents a fragmentary cross-sectional view of an airfoil surface region of a compressor blade of an industrial gas turbine in accordance with an embodiment of this invention.

### DETAILED DESCRIPTION OF THE INVENTION

The present invention provides an erosion and corrosion-resistant coating system that is particularly well suited for protecting components formed of iron-based alloys, and particularly industrial gas turbine compressor blades that are formed of martensitic stainless steels and subjected to water droplet erosion and corrosion pitting. Notable examples include first stage compressor blades formed of series 400 martensitic stainless steels such as AISI 403 and proprietary formulations such as GTD-450 precipitation-hardened martensitic stainless steel. While the invention will be described in reference to compressor blades formed of a stainless steel, it should be understood that the teachings of this invention will apply to other components that are formed of a variety of iron-based alloys and benefit from improved resistance to water droplet erosion and corrosion pitting.

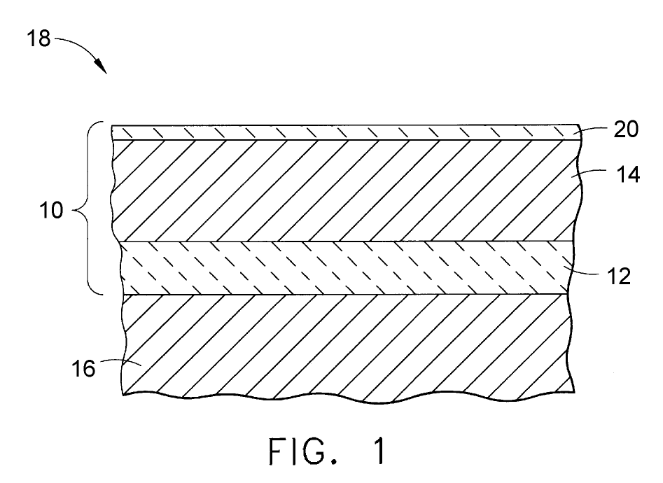

FIG. 1 schematically represents a coating system 10 of this invention as including a sacrificial undercoat 12 and a hard erosion-resistant ceramic topcoat 14 overlying the sacrificial undercoat 12. The undercoat 12 contains one or more metals or metal alloys that are above iron in the galvanic (electropotential) series, such that the undercoat 12 behaves as a sacrificial anode to an underlying substrate 16 of an iron-based blade 18. As such, the undercoat 12 and blade substrate 16 form a galvanic couple, and the undercoat 12 corrodes much more rapidly than any uncoated surface region of the blade 18. The erosion-resistant ceramic topcoat 14 provides water droplet and particle erosion protection, thereby preserving the sacrificial undercoat 12 and its ability to provide corrosion pitting and crevice corrosion resistance. The coating system 10 can be strategically placed on the compressor blade 18 with the individual thicknesses of the coating layers tailored to provide specific benefits for compressor airfoil applications.

The sacrificial undercoat 12 can be formed of a variety of compositions that are capable of the above-noted requirement of containing a sufficient amount of one or more metals or metal alloys above iron in the galvanic series to enable the undercoat 12 to serve as a sacrificial anode to the underlying iron-based blade substrate 16. Materials for the sacrificial undercoat 12 are also preferably capable of protecting the blade substrate 16 in the event the hard topcoat 14 is eroded away or otherwise spalls, especially in highly corrosive salt environments. In the event of loss of the topcoat 14, the undercoat 12 should also be capable of withstanding temperatures of at least 600° F. to about 1150° F. (about 320° C. to about 620° C.). A particularly preferred composition for the undercoat 12 is commercially offered by the General Electric Company under the name GECC1 (disclosed in U.S. Pat. No. 5,098,797 to Haskell), and contains cobalt and aluminum particles in a chromate/phosphate inorganic binder. The contents of Haskell relating to the GECC1 material, and particularly suitable compositions for the material and suitable particle sizes for the cobalt and aluminum particles, are incorporated herein by reference. Other candidate materials for the sacrificial undercoat 12 include nickel plating and zinc, both of which are known to perform as sacrificial anodes to iron and its alloys. Depending on the particular composition, suitable thicknesses for the sacrificial undercoat 12 are generally in a range of about five to about eight micrometers.

FIG. 1 schematically represents the coating system as further including a polymeric sealer 20 that seals the surface of the topcoat 14. The sealer 20 preferably provides protection from ingress of corrosive agents and also improves the solid-particle and water-droplet erosion characteristics of the topcoat 14 by virtue of its elastic nature. Suitable materials for the sealer 20 include phenolics, fluoropolymers, polyesters, rubbers, and vinyls, and suitable thicknesses for the sealer 20 are in a range of about 1 to 50 micrometers.

Following a suitable surface treatment such as grit blasting, the coating material is preferably applied by spray application using standard paint spray equipment to obtain a minimum of about 2 mils (about 50 micrometers) of total dry film thickness. The deposited layer is preferably dried for a minimum of fifteen minutes, optionally with forced air movement and/or at an elevated temperature, for example about 100° F. (about 40° C.). The dried layer is then cured at a minimum of about 500° F. (about 260° C.) for about thirty minutes or longer. These steps can be repeated to deposit additional layers to yield an undercoat 12 of desired thickness. The undercoat 12 is then burnished, such as by peening with glass beads or aluminum oxide (alumina) particles to consolidate the coating and ensure its electrical conductivity. To assess the latter, ohmmeter probes can be placed about one inch (about 2.5 cm) apart on the surface of the undercoat 12, with a reading of 10 ohms or less evidencing a suitable level of electrical conductivity.

The hard ceramic topcoat 14 must be harder and more resistant than the undercoat 12 and blade substrate 16 to erosion by water droplets at very high velocities. Erosion resistance of candidate materials can be preliminarily assessed using the Mohs scale of mineral hardness. For example, on the Mohs scale corundum (natural alumina; Al₂O₃) has a hardness of about 9, chromia (Cr₂O₃) has a hardness of about 8.5, quartz (silica; SiO₂) has a hardness of about 7, zirconia (ZrO₂) has a hardness of about 6.5, and titania (TiO₂) has a hardness of about 5.5 to 6.5. Mixtures of alumina and titania are reported to have hardnesses of about 6, and mixtures of alumina and zirconia are reported to have hardnesses of about 5.7. Based on the desire to maximize hardness, particularly preferred compositions are believed to be mixtures of alumina and titania, for example, by weight about 50/50, or 60/40, or 87/13, respectively, preferably about 70 to 99 weight percent alumina and the balance titania. Other candidates are also mixtures, and include mixtures of chromia and silica (for example, by weight about 95/5, respectively), mixtures of chromia and titania (for example, by weight about 45/55, respectively), mixtures of chromia, silica and titania (for example, by weight about, 92/5/3, respectively), and mixtures of zirconia, titania and yttria (Y₂O₃) (for example, by weight about 72/18/10, respectively). The particular ratios noted for these compositions are based on their erosion resistance being believed to be maximized at these ratios. However, it should be appreciated that these compositions are nominal. Wear resistance is also of interest, with both chromia and titania being reported as improving particle erosion in the literature.

To maximize the erosion protection afforded by coatings formed of the above hard ceramic materials, it is believed that deposition by thermal spray, and particularly plasma spray and high velocity plasma spray, is a preferred coating technique, as thermal spray processes are believed to improve the hardness of the powder particles used to form the coating. As known in the art, coating materials deposited by thermal spray processes are often initially in powder form, and then melted as the powder particles leave a spray gun. The molten particles deposit as “splats” on the targeted surface, resulting in the coating having noncolumnar, irregular flattened grains and a degree of inhomogeneity and porosity. In addition to plasma spray, which encompasses air plasma spray (APS) and low pressure plasma spray (LPPS; also known as vacuum plasma spray (VPS)), another notable thermal spray process is high velocity oxy-fuel (HVOF) deposition.

Because of the aerodynamic requirements of compressor blades, surface finish of the topcoat 14 is of importance, and the surface roughness of the topcoat 14 is preferably 100 microinches (abut 2.5 micrometers) Ra or less. Thermal spray processes also enable the ceramic topcoat 14 to be selectively deposited on the compressor blade 18, with the thickness of the topcoat 14 tailored to provide specific benefits for compressor airfoil applications. In particular, the ceramic topcoat 14 can be applied so that its thickness gradually decreases (fadeout) in the air flow direction across the airfoil surfaces of the blade 18 to minimize any adverse impact on aerodynamic efficiency. Nonetheless, it is foreseeable that a suitably hard ceramic topcoat 14 could be produced by other methods, such as a low-temperature vapor deposition process.

In preliminary investigations, air plasma sprayed (APS) alumina-titania topcoats have been shown to perform well in terms of erosion resistance, corrosion resistance, and compatibility with sacrificial undercoats of this invention. In each of the investigations, the test specimens were GTD-450 coupons coated by air plasma spraying mixtures of alumina and titania at alumina:titania weight ratios of about 55:45 to 97:3. The resulting coatings had thicknesses of approximately five mils (about 130 micrometers).

Water droplet erosion testing was completed in a rig configured for Dv90=700 micron droplets (90% of the water volume is contained in droplets 700 micrometers or smaller), at a rainfall rate of about 20 inches/hour (about 50 cm/hr). The spray was produced by a non-air assisted atomizing nozzle that generated an evenly dispersed full-cone shaped stream. Specimens traveled through the cone at about 777 m/sec. Testing of the alumina-titania coatings in this environment showed that coating breach was achieved after approximately 1.8 hours over the bare GTD-450 coupon substrates. Testing with smaller droplet sizes and with the sealer 20 would be expected to achieve improved results.

Solid particle erosion testing was conducted per the ASTM G76-2000 standard with the specimens at about 70° F. (about 20° C.). Weight loss was measured after shooting 50 Tm angular, white alumina with a pencil grit blaster at the coated substrate at a velocity of about 250 feet/second (about 76 m/s) and at angles of about 20 and 90 degrees. Erosion of the alumina-titania coatings showed weight losses of about 0.58 cc/1000 hrs at 20 degrees and about 2.23 cc/1000 hours at 90 degrees. It is believed that these erosion rates could be further reduced with the addition of the sealer 20, particularly the 90 degree weight loss values.

Corrosion tests with a salt fog have also been performed and have shown that a coating system combining an alumina-titania topcoat with a GECC1 sacrificial undercoat is resistant to corrosion. The corrosion tests were performed per ASTM B117, which is a standardized procedure well known in the art. Test specimens were subjected to a fog containing about 5% aqueous NaCl solution at a temperature of about 95° F. (about 35° C.). The fog settling rate and other recommendations were in accordance with the ASTM B117 standard. The tests were typically conducted for about one thousand hours, after which the test specimens were evaluated for corrosion attack. No corrosion on the surfaces of the test coupons was observe after the completion of the test.

From the aforementioned investigations, it was concluded that an alumina topcoat and metallic sacrificial undercoat is capable of exhibiting sufficient erosion and corrosion resistance to improve the life of a stainless steel compressor blade. Based on their ability to exhibit greater hardnesses, it was further concluded that titania-containing mixtures and particularly alumina-titania mixtures would exhibit comparable if not better erosion and corrosion resistance. The other topcoat compositions noted above also exhibit similar or greater hardnesses than alumina, and therefore are also viable candidates for the hard ceramic topcoat 14 of this invention. Suitable thicknesses for the topcoat 14 are generally in a range of about 25 to about 250 micrometers, more preferably about 50 to about 125 micrometers.

While the invention has been described in terms of specific embodiments, it is apparent that other forms could be adopted by one skilled in the art. For example, the coating system 10 could be overcoated by dipping, spraying, etc., a ceramic slurry that is cured to form an outer ceramic coating capable of providing additional protection from erosion. Therefore, the scope of the invention is to be limited only by the following claims.

1. A coating system on a steel substrate of a component, the coating system being resistant to corrosion and water-droplet erosion and comprising:
a metallic sacrificial undercoat on a surface of the substrate, the undercoat containing a metal or metal alloy that is more active in a galvanic series than iron, the undercoat electrically contacting the surface of the substrate; and
a ceramic topcoat deposited by thermal spray on the undercoat, the ceramic topcoat consisting essentially of a ceramic material chosen from the group consisting of mixtures of alumina and titania, mixtures of chromia and silica, mixtures of chromia and titania, mixtures of chromia, silica, and titania, and mixtures of zirconia, titania, and yttria.

2. The coating system according to claim 1, wherein the ceramic topcoat contains alumina.

3. The coating system according to claim 1, wherein the ceramic topcoat consists essentially of a mixture of alumina and titania.

4. The coating system according to claim 3, wherein the ceramic topcoat consists essentially of, by weight, about 50% up to about 99% alumina, the balance titania.

5. The coating system according to claim 1, wherein the ceramic topcoat contains chromia.

6. The coating system according to claim 1, wherein the ceramic topcoat consists essentially of a mixture of chromia and silica.

7. The coating system according to claim 6, wherein the ceramic topcoat consists essentially of, by weight, about 95% chromia and about 5% silica.

8. The coating system according to claim 1, wherein the ceramic topcoat consists essentially of a mixture of chromia and titania.

9. The coating system according to claim 8, wherein the ceramic topcoat consists essentially of, by weight, about 45% chromia and about 55% titania.

10. The coating system according to claim 1, wherein the ceramic topcoat consists essentially of a mixture of chromia, silica, and titania.

11. The coating system according to claim 10, wherein the ceramic topcoat consists essentially of, by weight, about 92% chromia, about 5% chromia, and about 3% titania.

12. The coating system according to claim 1, wherein the ceramic topcoat consists essentially of a mixture of zirconia, titania, and yttria.

13. The coating system according to claim 12, wherein the ceramic topcoat consists essentially of, by weight, about 72% zirconia, about 18% titania, and about 10% yttria.

14. The coating system according to claim 1, wherein the metal or metal alloy of the sacrificial undercoat comprises aluminum and cobalt particles consolidated within the undercoat.

15. The coating system according to claim 14, wherein the sacrificial undercoat further contains an inorganic binder comprising phosphate.

16. The coating system according to claim 1, wherein the sacrificial undercoat comprises a layer of nickel or zinc.

17. The coating system according to claim 1, wherein the component is a compressor blade of an industrial gas turbine, and the substrate is defines at least an airfoil surface of the blade.

18. The coating system according to claim 17, wherein the thickness of the ceramic topcoat gradually decreases in an air flow direction across the airfoil surface of the blade.

19. A process of forming a coating system on a steel compressor blade of an industrial gas turbine, the process comprising:
depositing a metallic sacrificial undercoat on an airfoil surface of the blade, the undercoat containing a metal or metal alloy that is more active in a galvanic series than iron, the undercoat electrically contacting the airfoil surface of the blade; and
thermal spraying a ceramic topcoat on the undercoat, the ceramic topcoat being harder and more resistant to water-droplet erosion than the undercoat and the airfoil surface of the blade, the ceramic topcoat consisting essentially of a ceramic material chosen from the group consisting of mixtures of alumina and titania, mixtures of chromia and silica, mixtures of chromia and titania, mixtures of chromia, silica, and titania, and mixtures of zirconia, titania, and yttria.

20. The process according to claim 19, wherein the sacrificial undercoat contains aluminum and cobalt particles consolidated within the undercoat, and an inorganic binder comprising phosphate.
